(19) United States
(12) Patent Application Publication
(10) Pub. No.: US 2016/0259509 A1
(43) Pub. Date: Sep. 8, 2016

(54) BACKEND-TO-FRONTEND WEBSITE DEVELOPMENT

(71) Applicant: Warhead, Inc., Redmond, WA (US)

(72) Inventors: Leif Alexander, Gig Harbor, WA (US); Gilbert Walker, Bellevue, WA (US)

(21) Appl. No.: 14/635,821

(22) Filed: Mar. 2, 2015

(51) Int. Cl. G06F 3/0484; H04L 29/12; G06F 17/22; G06Q 20/34; G06Q 20/38; G06Q 20/12; G06Q 20/06; H04L 29/08; G06F 3/0481

(52) U.S. Cl. CPC G06F 3/0484; H04L 67/02; H04L 61/20; G06F 17/2235; G06F 3/0481; G06F 17/2247; G06Q 20/382; G06Q 20/12; G06Q 20/065; G06Q 20/347

(57) ABSTRACT

In a website development tool, a web server is configured to communicatively couple to an Internet browser. An Internet browser opens a website administered by the web server. The website generates interactive objects associated with the backend processing of the web server. The website development tool includes a theme editor portion arranged to modify themes associated with pages of the website. When a modification command received at the theme editor requests a change to a first web page theme, a first theme identifier is communicated to a sector system controller. A theme draft is created based on the first theme, and a new URL is created by incorporating the theme draft's identifier into the original website URL. When the new URL is communicated to the web server, the web server delivers a web page having a control panel interface to the theme editor to the Internet browser via a proxy.

### BACKGROUND

1. Technical Field

The present disclosure generally relates to improving processing during development of a website and more particularly, but not exclusively, relates to methods and tools to move traditional backend server processing to a frontend browser level during the development of a website.

2. Description of the Related Art

Users of the World Wide Web, conventionally known as the Internet, generally recognize a website as a single entity. Software developers, however, recognize that a website typically includes a quantity of data, functional programs, scripts, and interpreted software that is hosted by one or more computing servers and delivered, via a network (e.g., the Internet) to a client's computing device. The client's computing device typically includes a software program conventionally known as an Internet browser (e.g., MICROSOFT INTERNET EXPLORER, APPLE SAFARI, MOZILLA FIREFOX, and GOOGLE CHROME).

In conventional use, a user accesses a website by typing a website name into an address bar of an Internet browser. The user's computing device has a unique address on the Internet, and the website has another unique address on the Internet. The Internet browser delivers the name of the desired website and the unique address of the user through a series of network connections and network computing devices to one or more particular computing servers called domain name servers (DNS). A DNS server looks up the name of the desired website and resolves the name to the unique address of the computing server that hosts the website. The initial user request to access the website is advanced through additional network paths and computing devices until the computing server that hosts the website is reached.

Upon receiving the request, the web server formulates information requested by the original user's Internet browser into a plurality of packets and delivers the packets back to the user's computing device. Upon receipt of the initial information, both the web server and the user's computing device are aware of each other's unique network address. From that point, the Internet browser on the user's computing device and the web server communicate across the Internet.

During the communication session, the user may click website hyperlinks, fill out forms, review “pages” of the website, and the like in an interactive fashion. Different scripts and algorithms may be running on the user's computing device and the website's computing server, which all contribute to the interactive experience the user has when accessing the website.

In many cases, a user's perception of website quality is based on how responsive the interaction is between the user's computing device and the website's computing server. The amount of available bandwidth across various network paths of the Internet affects the user's perception of quality. That is, some portions of the Internet allow data to travel more quickly than other portions. In addition, how quickly various algorithms execute also affect the user's perception of quality. That is, a computationally expensive algorithm (e.g., an algorithm that requires a high number of computing operations) executed on a website makes the website appear to the user to operate more slowly.

To improve the perception of higher quality, a website designer will often determine what types of computations will occur on the computing server of the website and what types of computations will occur on the user's computing device. Many of these decisions have already been made in the architecture of the conventional Internet. For example, it is recognized that the delivery of video over the Internet is made more efficient when the actual video data is algorithmically compressed, delivered in a compressed form to a user's computing device, and uncompressed by the user's computing device before delivery. In this way, the user's computing device can use dedicated hardware and software resources in the decompression algorithm and a smaller amount of actual video data can be delivered across the Internet. Conversely, some website activities such as database access and modification, server-side scripting, and large file manipulation are generally performed on the website's computing server, and the results of the activities are delivered across the Internet to the user's computing device.

When a website is developed, the website developer typically generates a group of related web pages having data (e.g., video, audio, text), scripts, algorithms, executable code, network links, and other software-based content that will execute on the website's computing server. When a webpage is loaded in the Internet browser on the user's computing device, packets of data are communicated between the user's computing device, the web server, and other computing servers and devices that are part of the network. The data is communicated in one, two, or many different directions.

Software practitioners typically create websites using individual software tools to create images, video, and text having the desired characteristics including how the created content will be presented to a user through an Internet browser. ADOBE PHOTOSHOP, for example, is one tool that is often used to prepare images for graphic display on a web page. Text editors such as ADOBE DREAMWEAVER are used to write executable web page program code (e.g., hyper-text markup language (HTML), extensible markup language (XML), JavaScript, and the like) that will determine how the website functions

Sometimes, software practitioners use an interactive development environment (IDE) to create websites. The IDE gives a software practitioner an opportunity to gather and create files or other compositions of data having many different types (e.g., images, text, audio, video, etc.) and inter-relate the data into a desirable group of web pages. Additionally, the software practitioner can author program code to execute functions based on the commands of a user that is accessing a website. The executed functions can navigate to other web pages of the website, navigate to other websites, serve multimedia content, perform algorithms, and perform nearly every other conceivable computing function.

A software practitioner using individual tools or an IDE can design a website in nearly any way. The software professional can design the web pages of the website to have colored backgrounds, none or many images, text of different fonts and sizes, products for sale, links to product pages, and many, many other types of objects. In some cases, the software practitioner will “drag and drop” images into templates, import images and other files from known locations, and include pre-written self-contained software functions. The objects on any given web page can be sized and positioned for presentation to a user according to any “look and feel” that the software practitioner desires.

The process of website development typically involves complex and time-consuming tasks. For at least this reason, website developers are often experienced software practitioners. The practitioners have access to computing web servers and computing user devices, and both types of computing machines are used during development. The software professional will develop content, or algorithms, or other material, upload the material to a computing web server, and test the material by accessing the computing web server with an Internet browser operating on the computing user device.

The subject matter discussed in the Background section is not necessarily prior art and should not be assumed to be prior art merely as a result of its discussion in the Background section. Along these lines, any recognition of problems in the prior art discussed in Background section or associated with such subject matter should not be treated as prior art unless expressly stated to be prior art. Instead, the discussion of any subject matter in the Background section should be treated as part of the inventor's approach to the particular problem, which in and of itself may also be inventive.

### BRIEF SUMMARY

In the past, website development has typically been undertaken as a time-consuming and inefficient iterative process. A website developer would make changes to the website software, test the changes locally, and then upload some or all portions of the website software and data to a web server so that full system testing could be performed.

Now, a new mechanism for website development has been created. The new mechanism permits browser-based website development using tools that have direct access to backend processing on the web server. Since the developer has direct access, changes to a website can be made in place while system-wide testing on the website happens in real time.

In a first embodiment, a website development method includes the act of operating a web server, the web server configured to execute backend processing and frontend processing, the web server configured to establish at least one frontend session communicatively coupling the web server to an Internet browser. The method also includes the act of opening a website with the Internet browser, the website addressed by a first uniform resource locator (URL), the website having a plurality of web pages, each web page of the website including a set of computer readable instructions, at least some of the computer readable instructions configured to create one or more interactive objects, the one or more interactive objects associated with the backend processing of the web server. A theme editor portion of the website development tool will be operated, the theme editor portion arranged to modify themes associated with webpages. In another act of the method, a modification command is received at the theme editor portion. The modification command is arranged to request a change to a first theme associated with a first web page, and based on the modification command, a first theme identifier of the first theme is communicated to a sector system controller. A theme draft based on the first theme is created, the theme draft having a theme draft identifier, and a new URL is created by incorporating the theme draft identifier into the first URL. The new URL is communicated to the web server and the method, and a webpage having a control interface to the theme editor portion is delivered.

The embodiment has many optional aspects. For example, in some cases, the backend processing may include financial transaction processing. The financial transaction processing in some cases includes at least one of credit card processing, encrypted payment processing, and bitcoin processing. In another aspect, the website development method also includes the acts of creating a proxy between the backend processing and the frontend session, and communicating information between the Internet browser and the web server via the proxy. In yet still another aspect, opening the website includes creating a session between the Internet browser and the frontend processing. The method may optionally include the act of making a copy of the first theme associated with the first web page, and the method may optionally include the acts of receiving user input to save the theme draft and updating the web server such that first theme identifier is directed to the information of the theme draft. In some cases, a first theme associated with the first web page defines a number of web page columns. In some cases, the website is a retail storefront website configured to display merchandise on merchandise web pages of the plurality of web pages and configured to permit users to purchase the merchandise via an Internet-based transaction.

In a second embodiment, a web server includes a processing unit, a transceiver, and a memory. A transceiver is configured to bi-directionally communicate information between a plurality of remote computing devices and the web server such that each remote computing device maintains at least one session identifying a communicative relationship between the web server and a respective Internet browser executing on each remote computing device. The memory is configured to store program instructions arranged to be executed by the processing unit. The program instructions are configured to perform several tasks, including executing web server backend processing logic and web server frontend processing logic, serving web pages of one more websites, wherein each website has a top-level domain uniform resource locator (URL), wherein each website has a plurality of web pages, wherein each web page includes a set of computer readable instructions, at least some of the computer readable instructions configured to create one or more interactive objects, the one or more interactive objects associated with the backend processing logic, wherein each web page is formatted according to a theme, the theme having an associated theme identifier. The program instructions are also configured to recognize a command from a first Internet browser to modify a first theme associated with a first web page, create a theme draft based on the first theme in response to the command to modify the first theme, the theme draft having a theme draft identifier, and communicate the theme draft identifier to the first Internet browser. A URL can be recognized as incorporating the theme draft identifier, a webpage having a control panel interface to a theme editor can be served, and at least one additional web page structured according to a modified theme, the modified theme directed by user input to the theme editor, can be served.

In some aspects of the second embodiment, the program instructions configure a proxy between the web server and a first computing device, the proxy arranged to communicate information between the backend processing logic and the first Internet browser. The backend processing logic may include financial transaction processing, and a URL of the first web page and the URL incorporating the theme draft identifier may share a common top-level domain. In some of the same or different aspects of the second embodiment, the program instructions are further configured to permit real-time manipulation of web pages associated with a first website that administers the first web page, to serve web pages constructed according to the modified theme, and to update the first theme in real-time based on a command from the first Internet browser to publish the first theme.

In still another embodiment, at least one non-transitory computer readable storage medium has stored contents to configure a computing system to perform a method. The method includes the acts of executing backend processing of a web server, executing frontend processing of the web server, and forming at least one frontend session communicatively coupling the web server to an Internet browser. The method includes the further acts of serving a plurality of web pages of a website, the website addressed by a first uniform resource locator (URL), at least one web page of the website including a set of computer readable instructions configured to create one or more interactive objects, the one or more interactive objects associated with the backend processing of the web server. Still additional acts include administering a theme editor, the theme editor configured to modify themes associated with web pages, receiving a request to modify a first theme associated with a first web page, and, based on the request, creating a theme draft based on the first theme, the theme draft having a theme draft identifier. In some cases, a new URL is recognized, the new URL having a portion formed from the first URL and a portion formed from the theme draft identifier. At least one modification to the theme draft is received from the Internet browser, and an updated web page structured according to the modified theme draft is delivered to the Internet browser.

Optionally in the embodiment, the computing system is configured to perform the method wherein opening the web page design editor comprises performing backend processing on information received from the Internet browser through the updated web page. The backend processing may include financial transaction processing. Optionally in the embodiment, the website may be a retail storefront website configured to display merchandise on merchandise web pages of the plurality of web pages and configured to permit users to purchase the merchandise via an Internet-based transaction. In still other optional cases, the stored contents may configure the computing system to perform the method such that opening the webpage design editor may include the acts of creating a proxy between the backend processing and the at least one frontend session, and communicating information between the Internet browser and the web server via the proxy.

Within the website development tools and methods discussed in the present disclosure, updates to a website are presented in an Internet browser in real time to the communication capabilities of Internet data traffic.

The innovation described in the present disclosure is new and useful, and the innovation is not well-known, routine, or conventional in the website development industry.

The innovation described herein uses known building blocks combined in new and useful ways along with other structures and limitations to create something more than has heretofore been conventionally known. The embodiments improve on computing systems which, when un-programmed or differently programmed, cannot perform or provide the specific web development features claimed herein.

Furthermore, the embodiments described in the present disclosure improve upon known web development processes and techniques.

The computerized acts described in the embodiments herein are not purely conventional and are not well understood. Instead, the acts are new to the industry. Furthermore, the combination of acts as described in conjunction with the present embodiments provides new information, motivation, and business results that are not already present when the acts are considered separately.

There is no prevailing, accepted definition for what constitutes an abstract idea. To the extent the concepts discussed in the present disclosure may be considered abstract, the claims present tangible applications of said allegedly abstract concepts.

The embodiments described herein use computerized technology to improve the technology of web development, but other techniques and tools remain available to develop websites. Therefore, the claimed subject matter does not foreclose the whole or even substantial web development technological area.

These features with other objects and advantages, which will become subsequently apparent, reside in the details of construction and operation as more fully described hereafter and claimed, reference being had to the accompanying drawings forming a part hereof.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 illustrates a system that allows backend processing in a web server to be moved into the frontend;

FIG. 2 is a block diagram of a web server;

FIG. 3 is an Internet browser window embodiment;

FIG. 4 is an exemplary embodiment of the backend to frontend system 100 during a web page modification operation; and

FIG. 5 is a flowchart setting forth a non-limiting method that makes use of the backend to frontend system 100 embodiment of FIGS. 1-4.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, have not been shown or described in detail to avoid unnecessarily obscuring descriptions of the embodiments.

In the past, conventional tools and methodologies were used to develop websites. Website development was an iterative and inefficient process. Significant drawbacks with the conventional approach were discovered, and the conventional tools and methodologies were replaced with a new website development environment (WDE). The WDE lets software practitioners design websites “live” in a theme editor. By integrating certain features in the WDE as floating windows, a software practitioner can now dynamically add and change content in a website, and the added and changed content can be concurrently tested.

The new website development environment (WDE) is described in U.S. patent application Ser. No. 13/969,219, filed Aug. 16, 2013, and included herein by reference in its entirety. Additional improvements to website development systems and methods have now been discovered by the inventors named herein.

Typical websites include both frontend processing and backend processing. Frontend processing (e.g., http:// . . . ) generally includes features of a website directly renderable via an Internet browser and interactively accessible to the computing device user. Often times, the features are unsecured and consist of presenting static or video images, audio, and text on the local display of a user's computing device as well as capturing input provided by the computing device user. Conversely, backend processing (e.g., https:// . . . ) generally includes access to features that are performed securely such financial transaction processing (e.g., credit card processing, encrypted payment processing, BITCOIN processing, secure checkout for an Internet-based payment, and the like), cryptographic processing, encryption services, decryption services, encoding/decoding, heat map creation and maintenance, real-time data processing, secure data processing, and the like. Under these constructs, wherein website development includes both frontend processing and backend processing, efficient, real-time development and testing has not been available.

The backend processing generally directs the flow of information through the website. In one example, a website generates a panel page, and places an HTML5 inline frame (i.e., an iframe) within the panel. The backend processing controlled iframe acts, in essence, like another browser window that has been set inside the web page. Using this technique, the backend processing portion of the website can control main pages of the website, and the backend processing can coexist peacefully with the frontend processing.

Problems arise, however, when the website's code base is modified and needs to be tested. If the modification and testing is occurring in the iframe, for example, conventional web development practices will copy the website code into a new location. The website code that was copied is referred to as “development code,” and the development code being modified is now stored in memory at a different location from the existing code base of the website. Creating the copy (i.e., development code) is done so that the website is not taken off-line during development or maintenance, but this practice makes it very difficult for a software practitioner to perform testing.

When the development code (i.e., the backend-controlled iframe code) is created, it resides in a new memory location that is different from the location where the website code base is stored. Since the development code is stored in a different location, the development (i.e., modified) version of the iframe will have a uniform resource locator (URL) that is different from the URL of the main pages of the website, which are controlled by the frontend processing. Security features in Internet browsers issue warnings and prevent URL mismatches that occur when the browser is directed to a first address for frontend processing and to a different second address for backend processing. This mismatch occurs because one or more modified parts of the website code are not in the same memory space as the other parts of the website, i.e., the live, publicly available parts, which are not being modified.

To avoid these types of warnings produced by the Internet browser, the URL address mismatches between frontend features and backend features must be avoided. One way to do this is to take the entire website off-line and test the website's entire code base as a unit. Once the testing is complete, the website is returned back online. This type of testing can be effective, but it is not desirable because the website is unavailable to consumers during the time the website is off-line.

A similar type of development and testing involves making a full copy of the website's entire code base and developing/testing the copy while the live website stays online. Once the testing is complete, the modified website is copied back to the location of the live website. In this way, there is only a brief period of time when the modified website is being copied to the original website location when the website is off-line and unavailable to customers. This type of testing can be effective, but it does not allow for full site-wide testing in a real live environment. In fact, results of this testing methodology can be seen in websites that function as coded but do not function as desired. Often, websites that are developed and tested only on local machines before being deployed on real web servers are perceived by users to be slow, inefficient, or otherwise challenging to use once they are put in service in the real world.

Another way to perform website testing while avoiding Internet browser URL mismatch warnings is to purposefully control where the development code will reside. For example, permitting a parent window to be owned by the frontend URL rather than the backend URL will allow the browser to test the frontend code without triggering URL errors. Taking this course of action, however, does not eliminate the problem. When the developer tries to navigate to different pages of the website, some of which require backend processing, the problems will again be made apparent via Internet browser warnings.

Yet one more way to perform website testing with an Internet browser is to kludge together various resources, which work to provide pseudo-live testing. In this technique, one or more “preview pages” are created to test the features under development. These preview pages provide an environment where localized testing can be performed, but again, true system-wide testing is not available. In this situation, similar as to when the ownership of particular windows is moved, features that cross the frontend/backend processing boundary cannot be tested in a live, real-world environment.

To illustrate at least some of the shortcomings with conventional web development technologies, an exemplary retail storefront website that displays merchandise on web pages is now discussed. When the website is deployed in the real world, consumers are permitted to browse through pages of merchandise and electronically purchase the merchandise. In this website, the display of text and images in the consumer's Internet browser is handled by the frontend processing logic of a web server, and the secure financial transaction is handled by the backend processing logic of the web server. Problematically, however, the full website cannot be live-tested because a “test purchase” that goes through the Internet browser involves both frontend processing to manage user input on the web page and backend processing to manage the secure payment checkout. Accordingly, to perform the testing, the developer will apply one or more of the conventional testing methodologies just described. That is, the developer will perform only limited testing in the frontend or in the backend, or the developer will take the entire website off-line to implement and test changes (usually in the middle of the night so as to have a low impact on consumers). Alternatively, and what often occurs, the developer will save their modified software, publish it to make it “go live,” and then test the modified features on the live website. While this potentially has a low impact on consumers, the testing process is long and inefficient.

The problem of URL mismatches caused during testing of features that use both frontend and backend processing is solved in the new backend to frontend system and methods described in the present disclosure.

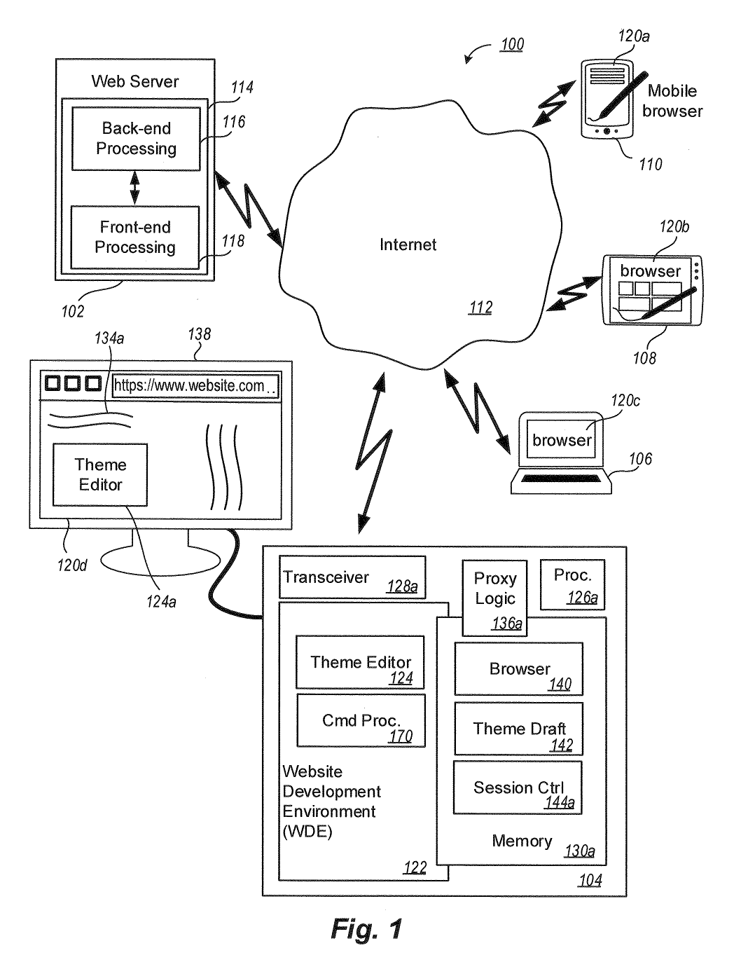

FIG. 1 illustrates a system that allows backend processing in a web server to be moved into the frontend. The backend to frontend system 100 illustrated in FIG. 1 includes several computing devices. A web server 102 hosts at least one website. A development computing device 104 is configured to modify the website. Several optional user computing devices are configured to access the website. FIG. 1 illustrates a laptop computer 106, a tablet 108, and a smart phone 110, but a wide range of other optional fixed user computing devices and mobile user computing devices are also considered. The computing devices are coupled together by a network 112.

In FIG. 1, the network is illustrated as a wide area network (WAN) such as the Internet, but other network architectures (e.g., local area network (LAN), personal area network (PAN), peer-to-peer communications, cellular networks, etc.) are also considered.

The computing devices of FIG. 1 include operative software found in conventional computing devices such as an operating system, software drivers that direct operations of input and output (I/O) circuitry, networking circuitry, storage devices, and other peripheral components. The computing devices typically also include operative application software such as network software for communicating with other computing devices, database software for building and maintaining databases, and task management software for distributing the communication and/or operational workload amongst various processing units.

In some cases, the computing devices are embodied as a single machine having the hardware and software described in this disclosure. In other cases, the computing devices are embodied as a networked collection of machines each having hardware and software configured such that the machines work together in a cloud, server farm, or some other functional topology. Many of the specific details of hardware and software embodied in the inventive prototypes tested are not shown for simplicity.

The web server 102 is hosting a website 114. Web server 102 may host many related or unrelated websites, but only a single website 114 is illustrated in FIG. 1 for simplicity. The website 114 typically has a plurality of web pages, and each webpage of the website is formed with a set of computer readable instructions. The computer readable instructions are configured to create one or more static objects and one or more interactive objects. Generally speaking, the static objects are administered by the frontend processing logic 118 of website 114, and the interactive objects are administered by the backend processing logic 116 of website 114.

The website 114 of web server 102 may be a retail storefront website, a banking website, a business information website, a government services website, or any other type of website. The website 114 is illustrated as having backend processing logic 116 and frontend processing logic 118.

The web server 102 is deployed in a real world environment. Users that are completely unassociated with the development and maintenance of the website can access the website through an Internet browser communicating over the Internet. As illustrated in FIG. 1, each of the user computing devices 106, 108, 110, is executing an Internet browser 120a, 120b, 120c, respectively.

When one or more users decide to access website 114, the users will open website 114 by entering a uniform resource locator (URL) in the address section of their Internet browser 120a-120c. The web server 102 is configured to establish at least one frontend session communicatively coupling the web server 102 to each Internet browser 120a-120c executing on the user's computing device. Subsequently, as the user navigates through different web pages of the website 114, a top level address (i.e., the URL domain name) will remain the same, but the complete address used by the Internet browser will change. This is because each web page of website 114 is executed from a common code base at a common root address, and each individual web page has its own separate sub-address.

Web server 102 will typically include a server-side scripting language processor of one type or another. For example, web server 102 may include a PHP hypertext preprocessor to process PHP scripts, which are blocks of software code written in the open source general-purpose PHP scripting language. Scripts such as these are widely used to provide the structural look and feel of a website such as website 114. The structural look and feel of website 114 may be described as its theme. Different themes may be created for particular Internet browsers, such as tablets, smartphones, laptop computers, and the like. Different themes may also be created for different pages of a website.

Exemplary features directed and controlled by the theme of website 114 include the layout structure of visible and invisible objects presented on the website, the number of columns, the size of columns, the number of rows, a palette of available colors, colors used in the website, available fonts and used fonts, languages, graphics, shapes, sizes, and the like.

In FIG. 1, the development computing device 104 is communicatively coupleable to web server 102 via network 112 (e.g., the Internet). Development computing device 104 is configured to modify website 114. The development computing device 104 includes a processor 126a, a transceiver 128a, memory 130a, and proxy logic 136a. Memory 130a is illustrated as including an Internet browser software application 140, a theme draft embodiment 142, and an Internet session controller 144a. As illustrated in FIG. 1, development computing device 104 is coupled to a presentation device 138 (e.g., a display). The development computing device 104 is executing the Internet browser software application 140, which presents an Internet browser window 120d on presentation device 138. Web page 134a of website 114 is displayed in the Internet browser window 120d on presentation device 138.

One portion of the website development environment (WDE) application 122 executing on the development computing device 104 is a themes controller portion, also known as a theme editor 124 software application. The theme editor 124 presents a theme editor floating window 124a within the Internet browser window 120d.

As illustrated in FIG. 1, a developer has “logged on” to a developer website (https://www.website.com) in order to make changes to the website. By logging on, the developer begins the process of gaining access to back-end functions of the website, including the website's themes.

The theme editor floating window 124a is generated with an iframe HTML tag, though other techniques may also be considered. In the figure, the theme editor floating window 124a is layered as a web page within web page 134a. In some cases, several theme editor windows can be generated in side-by-side manner, nested manner, docked manner, or in some other way.

The theme editor floating window 124a provides the functionality of a control panel interface to the themes controller portion. Using the theme editor 124 feature, a software practitioner can modify the theme of a website such as website 114. In some cases, a website has a single theme that every page of the website conforms to. In other cases, a website has different themes such that some or all of the pages of a website each have a different theme. The theme editor 124 is a tool that permits a user, via theme editor floating window 124a, to create, modify, and delete themes for some or all of the web pages of a website.

Another portion of the WDE application 122 is a command processor portion. The command processor 170 is configured to receive and process commands associated with various portions of the WDE application 122 such as the theme editor 124. In some cases, when a command is received and recognized by the command processor 170, the command processor 170 initiates and completes a particular action. In other cases, the command processor 170 may direct additional operations, for example, communicating information back to a web server 102

The WDE application 122 works cooperatively 136a with the Internet browser software application 140 to form a communicative coupling with website 114. The communicative coupling includes storing session formation information via session controller 144a, which provides a structural framework under which data is communicated between the website 114 and the WDE application 122.

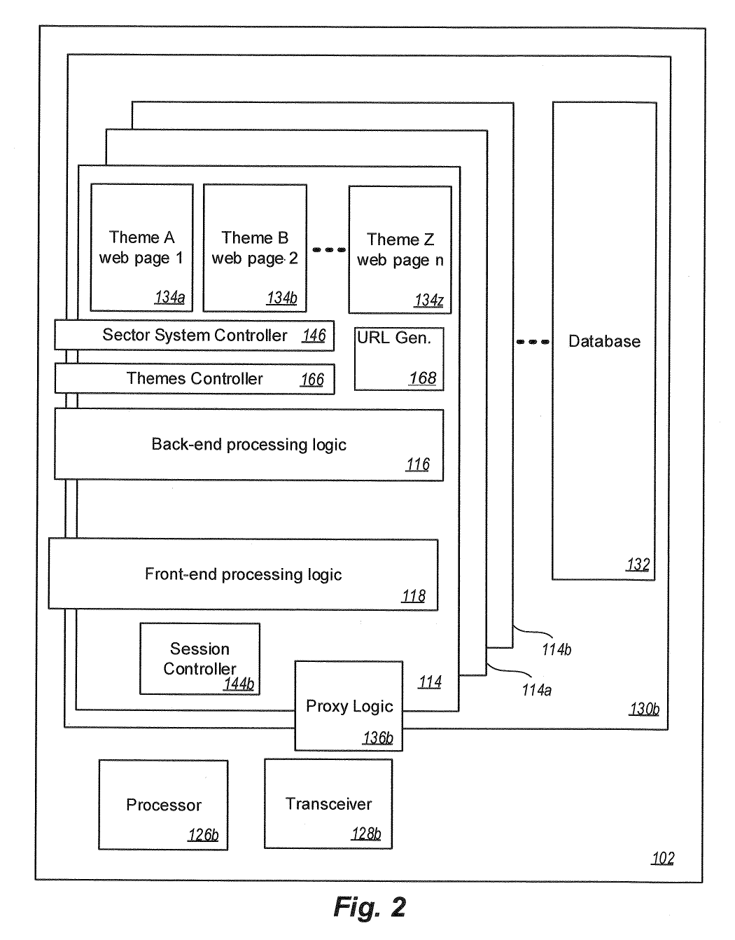

FIG. 2 is a block diagram of a web server 102. Web server 102 includes a processor 126b, a transceiver 128b, and a memory 130b. As recognized by one of ordinary skill in the art, web server 102 is a computing device that also includes other modules not shown for simplicity.

The memory 130b of web server 102 includes a database 132 and executable software and data formed as a plurality of websites 114, 114a, 114b. Each of the websites illustrated in FIG. 2 includes a plurality of webpages. Each web page of website 114 generally includes a set of computer readable instructions, at least some of the computer readable instructions configured to create one or more interactive objects, which may be associated with the backend processing logic 116 of the web server 102. Memory 130b may also include an Internet session controller 144b configured to store Internet session information related to communications between the website 114 and an Internet browser.

Website 114 is illustrated in FIG. 2 with a plurality of web pages including a first web page 134a, a second web page 134b, and so on to a final web page 134z. Generally speaking, a website can have any number of pages, limited only by the resources available to the web server 102.

The webpages of each website may include data stored in database 132 in any manner. Database 132 is illustrated in memory 130b within the web server 102. Alternatively, however, or in addition, it is understood that some or all of database 132 may reside remote from web server 102. The web server 102 can read and write data from a database 132 as directed by the program code of the website and the operations directed by the user.

Backend processing logic 116 and frontend processing logic 118 are illustrated in web server 102. The backend and frontend processing logic may include executable software instruction logic and data portions that are stored in memory 130b. The backend and frontend processing logic may also include circuitry or other logic distinct from memory 130b.

A sector system controller 146 may include executable software instruction logic and data portions stored in memory 130b, and the sector system controller 146 may also include circuitry or other logic to carry out certain website functions associated with the look and feel of the web page presentation.

In some cases, website 114 is designed on a form known as “digital graph paper” having columns and rows of grid blocks. The digital graph paper provides an alignment structure that each web page of a website can be ordered around. One or more separately identifiable groups of grid blocks are considered to be a “sector.” Sectors can span one or more rows, and sectors can span one or more columns. Various portions of website 114 occupy different sectors on the webpage. In this way, a sector system is useful in defining, manipulating, and modifying the theme of a website. Within the web server 102, the sector system controller 146 processes web page data and directs the broad look and feel of a web page as it is presented through an Internet browser.

A themes controller 166 cooperates with the sector system controller 146 and other modules of the web server 102. The themes controller 166 is arranged to store and retrieve information from themes associated with each web page 134a-134z. The themes controller 166 prepares the theme information in cooperation with information from the sector system controller 146 for communication to an Internet browser executing on a remote computing device. Backend processing logic 116 generally controls the themes controller 166. For example, when a website is being developed or modified, the themes controller 166 administers templates, creates copies of existing themes, and retrieves and stores theme data from memory (e.g., database 132).

A uniform resource locator (URL) generator 168 is configured in the web server 102 to generate web page addresses. Each page in a website such as website 114 has a different, system-wide unique address. The unique address of the website in context of the global Internet or other network is not relevant in the present disclosure; however, one of skill in the art will understand how an Internet URL includes a top level domain and how the URL is resolved to a unique numerical address within the network.

The URL generator 168 is configured to generate the addresses of the plurality of web pages of the website. In addition, as a software practitioner creates new web pages, the URL generator 168 creates corresponding URLs.

Proxy logic 136b is configured in web server 102. Some portions of proxy logic 136b may be formed in memory 130b, such as software instruction logic and data. Other portions of proxy logic 136b may be formed in circuitry or other logic distinct from memory 130b. Via the proxy logic, remote processing may occur in an external computing device as if the processing is occurring within web server 102. In this way, the proxy creates a communication pipeline between the backend and the frontend, and services generally associated with backend processing are moved into the frontend.

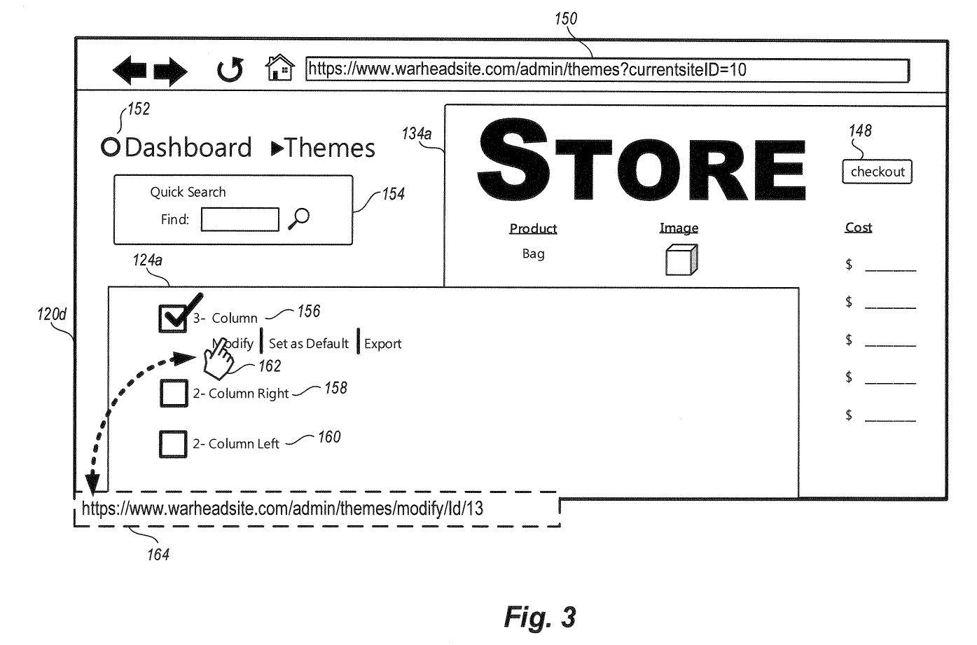

FIG. 3 is an Internet browser window 120d embodiment that may be presented on the presentation device 138 of development computing system 104. Within the browser window 120d, a representation of website 114 is presented; web page 134a in particular is illustrated. In this case, website 114 is a retail storefront website. Website 114 has a plurality of pages; however, in FIG. 3, only a single web page 134a is shown, but other web pages can be navigated to by the software practitioner. The illustrated web page 134a in FIG. 3 is configured to display merchandise on a merchandise web page of website 114. Various sectors of web page 134a are seen in FIG. 3 including a main sector bearing a “STORE” identifier and a checkout button 148. The web page 134a also illustrates three additional sectors formed as columns. A first sector identifies a product being sold, which in FIG. 3 is a bag, a second sector identifies an image of the product being sold, and a third sector identifies the cost of each item. The web pages 134a-134z (FIG. 2) of website 114 are configured to permit users to purchase the merchandise via an Internet-based transaction.

The Internet browser window 120d of FIG. 3 includes an address window 150. In the present case, address window 150 is configured for entry of alphanumeric and character text using a keyboard, a mouse, a voice entry system, or some other mechanism. The address window 150 permits a user to direct the Internet browser software application 140 to navigate to a particular website. The address window 150 also acts as a status window informing a user of a current Internet address. It is recognized that other input mechanisms may be used with Internet browser software applications now and in the future.

Certain features of the website development environment (WDE) application 122 are also presented in the Internet browser window 120d. A breadcrumbs feature 152 provides status and navigation information to a software practitioner. The breadcrumbs feature 152 acts as a roadmap for the software practitioner showing where in the WDE application 122 current focus is present. The different elements of the breadcrumbs feature 152 may be selected by the software practitioner to advance or retreat navigation within WDE 122. A search feature 154 enables the software practitioner a different opportunity to navigate within the WDE application 122.

A theme editor floating window 124a is shown hovering over the web page of website 114 and within the Internet browser window 120d. The theme editor 124 software application is a feature provided by the WDE application 122 that permits a software practitioner to alter the structure of a website using vision-based tools. By way of the theme editor 124, a software practitioner can make changes to one or more web pages of website 114 in real time, and visually, the software practitioner can see the result of the changes as the changes are being made. Furthermore, in many cases, the software practitioner does not need to write software code to make the changes. Instead, grid blocks can be selected and de-selected, various parameters can be set through dialog boxes, and other visual tools can be used to modify a website, and the modifications can be presented in a “live preview.”

Favorably, the theme editor floating window 124a can be re-sized, re-shaped, and re-positioned to efficiently use the available display area of the development computing device. In some cases, the floating panel is kept on top of other windows, and in other cases, the floating panel is “minimized” or permitted to be covered by other windows of the development computing system. In these or still other embodiments, the theme editor floating window 124a may be broken up into two or more different windows to duplicate functionality or separate functionality of the theme editor.

Three particular features are illustrated in the theme editor 124 floating window 124a; however, many other features can also be modified. The features illustrated in FIG. 3 include a web page having three columns 156, a web page having two right-justified columns 158, and a web page having two left-justified columns 160. The current selection, as indicated by the check mark, is a web page having three columns 156. This is evident in the illustrated web page 134a of website 114, which has three columns (i.e., a product column, an image column, and a cost column).

A selection pointer 162 in the shape of a hand is shown hovering above the theme editor floating window 124a. Since the web page having three columns 156 feature has been selected, the software practitioner may take certain actions to modify, set as default, or export the theme feature. Other actions are of course envisioned. In FIG. 3, the software practitioner is hovering the selection pointer 162 above the “modify” feature, which indicates that the software practitioner would like to change the structure of a web page 134a of website 114. A floating address window 164 corresponding to the link below the selection pointer 162 is illustrated in dotted lines.

The floating address window 164 illustrates an address representative of a modifiable web page 134a of website 114. The address in the floating address window 164 is a uniform resource locator (URL). The address in the floating window 164 bears some similarities to the address in the Internet browser address window 150. In particular, the two addresses have the same top level domain identifier as shown in (1):
www.warheadsite.com (1)

Although the addresses illustrated in FIG. 3 themselves are non-limiting, and nearly any website may be modified using the backend to frontend techniques of the present disclosure, the address in the address window 150 and the address in the floating address window 164 are both directed to a common memory space. Since both addresses are directed to a common memory space, the Internet browser software application 140 will not identify address mismatch problems when information flows between the two webpages.

In FIG. 3, information presented through the web page of website 114 may be handled by the frontend processing logic 118 of web server 102. Other information that passes through the website, when a user selects checkout button 148 for example, may be handled by the backend processing logic 116 of web server 102. As illustrated in FIG. 3, a software practitioner is acting to modify the structure of web page 134a of website 114 via the theme editor 124 feature. The structural aspects of each web page of website 114 are administered by the backend processing logic 116 of web server 102.

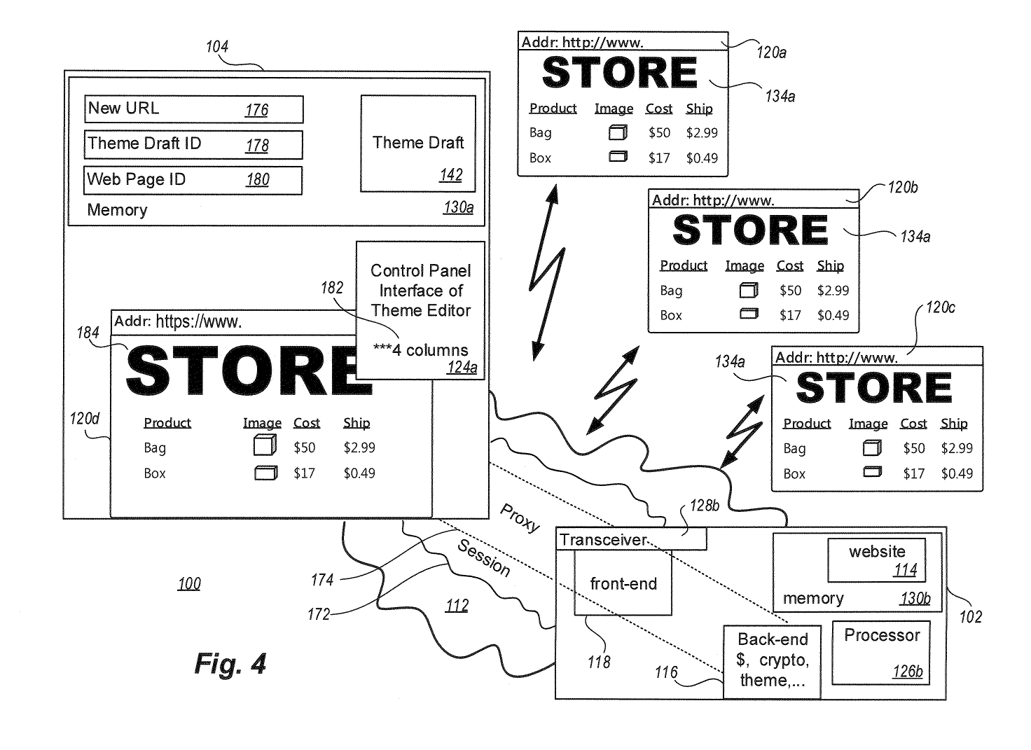

FIG. 4 is an exemplary embodiment of the backend to frontend system 100 during a web page modification operation. Certain portions of the web server 102 are illustrated, including a transceiver 128b, processor 102, and memory 130b having stored therein the plurality of pages of website 114. The web server 102 also includes frontend processing logic 118 and backend processing logic 118. The backend processing logic 118 is illustrated with exemplary backend computing features including financial transaction processing, cryptography, and administrative processing of a website's themes.

The embodiment of FIG. 4 is illustrated as including communicative website sessions with several devices. Three particular Internet browser windows 120a-120c are shown. Each of the three Internet browser windows is displaying a first web page 134a of website 114. The Internet browser windows may be associated with any type of computing device, and the user of the respective computing device has navigated the Internet browser software to website 114.

A development computing device 104 is also illustrated in FIG. 4. A software practitioner operating development computing device 104 has created a session 172 between an associated Internet browser software application and the frontend processing logic 118 of web server 102. It is recognized that other computing devices (e.g., laptop computer 106, tablet computer 108, a smart phone 110, and the like) may also create sessions between their associated Internet browser software application and the frontend processing logic 118 of web server 102, but these other sessions are not illustrated, for simplicity.

Within the parameters of session 172, a proxy communication path 174 has also been created between the backend processing 116 of web server 102 and the Internet browser software application of the development computing device 104. The proxy communication path 174 is used to communicate information between development computing device 104 and the web server 102.

The development computing device 104 in FIG. 4 illustrates a theme editor floating window 124a associated with the Internet browser window 120d. The theme editor floating window 124 indicates that a software practitioner has structurally modified a theme of web page 134a to now have four columns 182, whereas previously, web page 134a had only three columns. The modified web page 184 is shown in FIG. 4.

Memory 130a of development computing device 104 includes additional exemplary memory fields. Other structures, data, and aspects of memory 130a are not shown in FIG. 4, for simplicity of illustration. Memory 130a includes a new URL 176 data structure field, a theme draft identifier (ID) 178 data structure field, and a web page ID 180. Memory 130a also includes a theme draft 142.

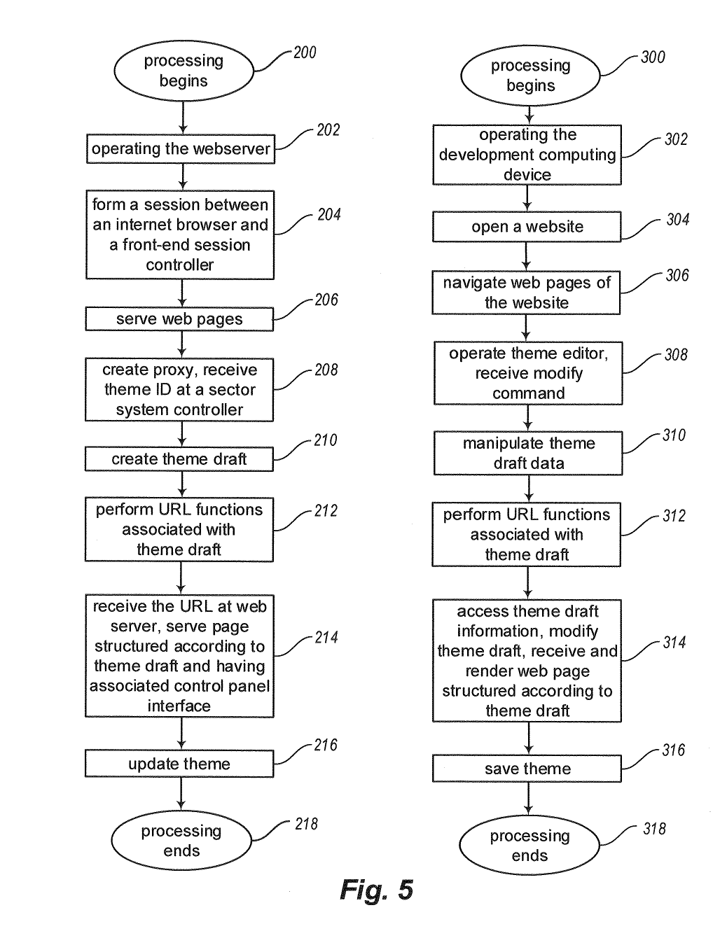

FIG. 5 is a flowchart setting forth a non-limiting method that makes use of the backend to frontend system 100 embodiment of FIGS. 1-4. The flow chart of FIG. 5 includes processing of both web server 102 and development computing device 104. Processing in the web server 102 begins at 200. Processing in the development computing system 104 begins at 300.

At 202 the web server is operating. The web server is configured to execute backend processing and front-and processing. At 302, the development computing device is operating. The software practitioner operating in the development computing device desires to open a website with an Internet browser software application.

At 304, the software practitioner begins the process of opening a website. The website is addressed by a uniform resource locator (URL), and the website has a plurality of webpages. The pages of the website include a set of computer readable instructions, and at least some of the computer readable instructions are configured to create interactive objects. The interactive objects are associated with the backend processing of the web server.

At 204, the web server and the development computing device cooperate to create a frontend session. The web server and the development computing device are communicatively coupled to each other through the session. More particularly, the web server and the development computing device each have a form of session controller, and the session controllers communicate to pass data through respective transceivers of the devices.

Via the session, at 306, the software practitioner is able to navigate the website. In the exemplary embodiment, the website is a retail storefront website configured to display merchandise on particular merchandise webpages. The software practitioner, or any user through their own computing device, may navigate the retail storefront website. At 206, the pages of the website navigated by a user are served by web server. The web pages of the website are configured to permit users to purchase merchandise via an Internet-based transaction.

If a user makes a purchase on the website, the Internet-based transaction will typically include some type of secure checkout function. The secure checkout function of a website facilitates a financial transaction. In some cases the financial transaction processing includes credit card processing. In these or alternative cases, the financial transaction processing may also include encrypted payment processing and bit coin processing. These financial transaction operations are typically administered by the backend processing of the web server. In this case, information is communicated between the backend processing logic of the web server, through the frontend logic, and the Internet browser.

At 308 the software practitioner begins to take action to modify a page of the website. In this example, the software practitioner desires to make a structural change to at least one page of the website. The software practitioner initiates a theme editor software application. The theme editor software application may be a stand-alone utility or a portion of a website development environment (WDE) application. The theme editor software application enables the software practitioner to review some or all of the structure of one or more web pages of the website. In some cases, the theme editor software application draws the information from the web pages as they are displayed. In addition, or in the alternative, the development computing device may pass requests to the web server to retrieve the structural information of the website's theme.

Using the theme editor software application, the software practitioner can modify one theme associated with one or more web pages. Alternatively, or in addition, the software practitioner can modify many different themes. A command processor associated with the theme editor software application or associated with the WDE is configured to receive a modification command, which is arranged to request a change to a theme associated with a web page the software practitioner would like to modify.

At 208, based on the software practitioner's desire to modify a theme of a web page, a proxy will be created between the backend processing logic of the web server and the frontend session created between the web server and the Internet browser. The proxy will permit information to flow between the development computing device and the web server as if the two computing devices were sharing a common memory space. In some cases, the proxy is initiated by the web server. In other cases, the establishment of the proxy begins with the development computing device.

The particular theme of a web page includes an identifier (ID) to the theme. The ID may be numerical, alphanumerical, or the ID may take some other form. In some cases, the ID points to a particular area of memory where theme structural information is stored. A sector system controller in the web server is able to retrieve information associated with a theme, and in some cases, the sector system controller uses the theme ID to retrieve the information. In other cases the sector system controller uses another technique to access the theme information. The sector system controller is arranged to use the theme information to generate software instructions that inform the Internet browser how to render a web page.

The web server will generate a theme draft having its own theme draft identifier. The theme draft may be a bit-for-bit copy of the theme that is being modified. Alternatively, the theme draft may include only theme information that has been changed or will be changed. Accordingly, the theme draft may be stored in the web server, the development computing device, or both the web server and the development computing device. In this respect, the theme draft may also be created in the development computing device.

At 212 and 312, URL functions associated with the theme draft are performed. One function is the creation of a new URL. The new URL will incorporate the theme draft identifier into the URL of the website. For example, the website will have a home page. Typically, though not necessarily, the homepage is reached via the top level domain URL. When the web server encounters the top level domain or some other derivative URL, (e.g., an administrative domain), the web server may open a particular page or redirect navigation to some other page. When the theme draft is created, the new URL that is assigned to the theme draft will be associated with an address having a common root address shared by the other webpages of the website. By incorporating the theme draft ID into the URL of the theme draft, the theme draft will be considered by Internet browsers to be part of the website.

The new URL is received at the web server at 214, and at 314 the development computing device will access theme draft information. The new URL, which is associated with a web page formed according to the draft theme, may be received from the development computing device. In response, the web server will serve a web page structured according to the theme draft information. In some cases, the web server creates a new iframe that is loaded over the top of the main page of the website. In these cases, and in other cases, the web server will then serve a web page that also has an associated control panel interface (e.g., an interface to the theme editor), and the web page will be received and rendered by the Internet browser of the development computing device. Information communicated between the Internet browser and the web server will be passed via the proxy.

As illustrated in FIG. 4, the software practitioner is making an exemplary change to the theme of web page 134a. Several computing devices are rendering web page 134a as a web page having three columns of merchandise information. In the development computing device, however, the Internet browser application is rendering a modified web page 184 in Internet browser window 120d. Modified web page 184 has been restructured to include four columns. As specifically illustrated, a portion of the first web page 134a has three columns labeled, “Product,” “Image,” and “Cost.” In contrast, the modified webpage 184 has four columns labeled, “Product,” Image,” “Cost,” and “Shipping.” The number of columns of the web page is defined by the theme, and when the web page is rendered as structured by the theme, the user will recognize that the webpage has a look and feel with a particular number of columns.

Turning back to FIG. 5, at 316, the software practitioner provides input to save the theme draft. In this case, the software developer is pleased with the change to the web page increasing the number of columns from three to four. It is recognized that the software practitioner could have made many other changes in many different ways. Using the theme editor's floating window, which acts as a control panel interface to the theme editor, the software practitioner can make nearly any change to the look and feel (i.e., the theme) of the web page. The software practitioner may change only a single page, or the software practitioner may propagate the changes across many pages, including all of the pages of the website.

As the software practitioner makes all of these changes, the theme draft is updated, and the web page is restructured and re-rendered via the Internet browser application software of the development computing device. In this way, the changes to the web page are made on the fly, and the software practitioner can see the changes immediately in real-time. The software practitioner can also navigate the website away from the web page that is being modified and back to the web page that is being modified. The software practitioner can navigate to any of the other website pages, and the software practitioner can interact with the website. In the present example, the software practitioner can perform a secure transaction to make a test purchase or real purchase including a financial transaction. Since the development computing device is storing information of the new URL, theme draft ID, webpage ID, and the like, the development computing system can generate proper URLs for unmodified web pages and modified webpages. Because the proxy has been configured, backend processing is moved to the frontend system, and URL addresses remain configured according to a common root address.

At 216, the theme draft is saved in the web server. Saving the theme draft may include copying the theme draft back to the location of the original theme that was modified. Alternatively, the identifier of the original theme may be redirected to the theme draft. One of skill in the art will recognize that updating the original theme draft can be performed by modifying, copying, or replacing the original, or by employing a different software technique. Once the modified theme draft has been saved, and the original theme draft is now updated, the changes to the website are “live.” That is, the changes to the website become immediately available to other users who navigate to the website. With respect to FIG. 4, once the modified theme has been saved, a refresh on any of Internet browser windows 120a, 120b, or 120c, will render a web page that looks like webpage 184.

Processing ends in the web server at 218, and processing ends in the development computing device at 318.

As used in the present disclosure, the term “module” refers to an application specific integrated circuit (ASIC), an electronic circuit, a processor and a memory operative to execute one or more software or firmware programs, combinational logic circuitry, or other suitable components (hardware, software, or hardware and software) that provide the functionality described with respect to the module.

A processor (i.e., a processing unit), as used in the present disclosure, refers to one or more processing units individually, shared, or in a group, having one or more processing cores (e.g., execution units), including central processing units (CPUs), digital signal processors (DSPs), microprocessors, micro controllers, state machines, and the like that execute instructions.

In the present disclosure, memory may be used in one configuration or another. The memory may be configured to store data. In the alternative or in addition, the memory may be a transitory or non-transitory computer readable medium (CRM) wherein the CRM is configured to store instructions executable by a processor. The instructions may be stored individually or as groups of instructions in files. The files may include functions, services, libraries, and the like. The files may include one or more computer programs or may be part of a larger computer program. Alternatively or in addition, each file may include data or other computational support material useful to carry out the computing functions of the systems, methods, and apparatus described in the present disclosure.

Certain figures illustrate portions of non-limiting computing device embodiments (e.g., servers, personal computers, laptop computers, thin clients, tablet devices, mobile devices, wearable devices). The computing devices include operative hardware found in a conventional computing device apparatuses such as one or more processing units, volatile and non-volatile memory, serial and parallel input/output (I/O) circuitry compliant with various standards and protocols, wired and/or wireless networking circuitry (e.g., a communications transceiver), and other modules. Typically, the computing devices may be configured with input and output (I/O) interfaces for cooperative operations with a variety of I/O devices such as keyboards, mice, touch pads, trackballs, microphones, cameras, motion recognition devices, speakers, presentation devices (e.g., displays), and the like.

As known by one skilled in the art, a computing device has one or more memories, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory. The memory in some cases is a non-transitory computer medium configured to store software instructions arranged to executed by a CPU.

The computing device further includes operative software found in a conventional computing device such as an operating system, software drivers to direct operations through the I/O circuitry, networking circuitry, and other peripheral component circuitry. In addition, the computing device includes operative application software such as network software for communicating with other computing devices, database software for building and maintaining databases, and task management software for distributing the communication and/or operational workload amongst various CPU's. The operating system software may include any one or more of various versions of LINUX, MICROSOFT WINDOWS, UNIX, and others. Web page management and administration tool software may optionally be configured as one or more web server modules, database server interface modules, script processor modules, and web browser modules. Examples of web server modules include APACHE, MICROSOFT INTERNET INFORMATION SERVICES (IIS), NGINX, and GOOGLE WEB SERVER (GWS). The web server modules typically deliver web pages to client devices. Requests to receive web pages are often made using the Hypertext Transfer Protocol (HTTP), and the web pages are often delivered as Hypertext Markup Language (HTML) documents along with any additional content that is called out by the document (e.g., images, style sheets, scripts, functions, and the like).

Examples of database server interface modules include ORACLE/SUN MICROSYSTEM MYSQL, MICROSOFT SQL SERVER, and APACHE DERBY. A database server interface module often implements a structured query language (SQL) that performs input and output functions on a relational database. In some cases, a database server interface module implements a data storage repository (e.g., a relational database) in the same hardware that implements the database server, and in other cases, the repository is distributed between several different machines. In some cases, the data repository is implemented in a database server and the database server interface module is implemented in a computing server (e.g., a web server).

A computing server may include a script processor, which is a computing module that interprets and executes instructions of a scripting language. PHP is one example of a scripting language. MICROSOFT ACTIVE SERVER PAGES (ASP) is another example. In some cases, the scripting language is embedded into the HTML source code of a web page, and interpreted by the script processor module.

In some cases, the computing device is a single hardware machine having the hardware and software listed herein, and in other cases, the computing device is a networked collection of hardware and software machines working together in a server farm to execute the functions of the Internet website development environment 100. Some aspects of the conventional hardware and software of the computing device is not shown in the figures for simplicity.

In the foregoing description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, e.g., “including, but not limited to.”

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A website development tool method, comprising:
operating a web server, the web server configured to execute backend processing and frontend processing, the web server configured to establish at least one frontend session communicatively coupling the web server to an Internet browser;
opening a website with the Internet browser, the website addressed by a first uniform resource locator (URL), the website having a plurality of web pages, each web page of the website including a set of computer readable instructions, at least some of the computer readable instructions configured to create one or more interactive objects, the one or more interactive objects associated with the backend processing of the web server;
operating a theme editor portion of the website development tool, the theme editor portion arranged to modify themes associated with web pages;
receiving a modification command at the theme editor portion, the modification command arranged to request a change to a first theme associated with a first web page;
based on the modification command, communicating a first theme identifier of the first theme to a sector system controller;
creating a theme draft based on the first theme, the theme draft having a theme draft identifier;
creating a new URL by incorporating the theme draft identifier into the first URL;
communicating the new URL to the web server; and
delivering, from the web server to the Internet browser, a web page having a control panel interface to the theme editor portion.

2. The website development tool method of claim 1 wherein the backend processing includes secure checkout processing for an Internet-based payment.

3. The website development tool method of claim 1 wherein the backend processing includes financial transaction processing.

4. The website development tool method of claim 3 wherein the financial transaction processing includes at least one of credit card processing, encrypted payment processing, and bitcoin processing.

5. The website development tool method of claim 1, comprising:
creating a proxy between the backend processing and the frontend session; and
communicating information between the Internet browser and the web server via the proxy.

6. The website development tool method of claim 1 wherein opening the website includes creating a session between the Internet browser and the frontend processing.

7. The website development tool method of claim 1 wherein creating the theme draft, comprises:
making a copy of the first theme associated with the first web page.

8. The website development tool method of claim 1 wherein the first theme associated with the first web page defines a number of web page columns.

9. The website development tool method of claim 1 wherein the website is a retail storefront website configured to display merchandise on merchandise web pages of the plurality of web pages and configured to permit users to purchase the merchandise via an Internet-based transaction.

10. The website development tool method of claim 1, comprising:
receiving user input to save the theme draft; and
updating the web server such that first theme identifier is directed to information of the theme draft.

11. A web server, comprising:
a processing unit;
a transceiver to bi-directionally communicate information between a plurality of remote computing devices and the web server such that each remote computing device maintains at least one session identifying a communicative relationship between the web server and a respective Internet browser executing on each remote computing device; and
a memory, the memory having stored program instructions arranged to be executed by the processing unit, the program instructions configured to:
execute web server backend processing logic;
execute web server frontend processing logic;
serve web pages of one or more websites, wherein each website has a top-level domain uniform resource locator (URL), wherein each website has a plurality of web pages, wherein each web page includes a set of computer readable instructions, at least some of the computer readable instructions configured to create one or more interactive objects, the one or more interactive objects associated with the backend processing logic, wherein each web page is formatted according to a theme, the theme having an associated theme identifier;
recognize a command from a first Internet browser to modify a first theme associated with a first web page;
create a theme draft based on the first theme in response to the command to modify the first theme, the theme draft having a theme draft identifier;
communicate the theme draft identifier to the first Internet browser;
recognize a URL incorporating the theme draft identifier;
serve a web page having a control panel interface to a theme editor; and
serve at least one additional web page structured according to a modified theme, the modified theme directed by user input to the theme editor.

12. The web server according to claim 11 wherein the program instructions are further configured to:
configure a proxy between the web server and a first computing device, the proxy arranged to communicate information between the backend processing logic and the first Internet browser.

13. The web server according to claim 11 wherein the backend processing logic includes financial transaction processing.

14. The web server according to claim 11 wherein a URL of the first web page and the URL incorporating the theme draft identifier share a common top-level domain.

15. The web server according to claim 11 wherein the program instructions are further configured to:
permit real-time manipulation of web pages associated with a first website that administers the first web page;
serve web pages constructed according to the modified theme; and
update the first theme in real-time based on a command from the first Internet browser to publish the first theme.

16. At least one non-transitory computer readable storage medium whose stored contents configure a computing system to perform a method, the method comprising:
executing backend processing of a web server;
executing frontend processing of the web server;
forming at least one frontend session communicatively coupling the web server to an Internet browser;
serving a plurality of web pages of a website, the website addressed by a first uniform resource locator (URL), at least one web page of the website including a set of computer readable instructions configured to create one or more interactive objects, the one or more interactive objects associated with the backend processing of the web server;
administering a theme editor, the theme editor configured to modify themes associated with web pages;
receiving a request to modify a first theme associated with a first web page;
based on the request, creating a theme draft based on the first theme, the theme draft having a theme draft identifier;
recognizing a new URL, the new URL having a portion formed from the first URL and a portion formed from the theme draft identifier;
receiving from the Internet browser at least one modification to the theme draft; and
delivering to the Internet browser, an updated web page structured according to the modified theme draft.

17. The at least one non-transitory computer readable storage medium according to claim 16 whose stored contents configure the computing system to perform the method wherein opening a web page design editor comprises:
performing backend processing on information received from the Internet browser through the updated web page.

18. The at least one non-transitory computer readable storage medium according to claim 16 whose stored contents configure the computing system to perform the method wherein the backend processing includes financial transaction processing.

19. The at least one non-transitory computer readable storage medium according to claim 16 whose stored contents configure the computing system to perform the method wherein the website is a retail storefront website configured to display merchandise on merchandise web pages of the plurality of web pages and configured to permit users to purchase the merchandise via an Internet-based transaction.

20. The at least one non-transitory computer readable storage medium according to claim 16 whose stored contents configure the computing system to perform the method wherein opening the web page design editor comprises:
creating a proxy between the backend processing and the at least one frontend session; and
communicating information between the Internet browser and the web server via the proxy.
